(19) United States
(12) Patent Application Publication
(10) Pub. No.: US 2010/0247944 A1
(43) Pub. Date: Sep. 30, 2010

(54) HYDROGEN-PERMEABLE MEMBRANE MADE OF A METAL COMPOSITE MATERIAL

(75) Inventors: Leslaw Mleczko, Dormagen (DE); Juergen Kintrup, Emsdetten (DE); Ralph Weber, Leichlingen (DE); Andre Dammann, Koeln (DE); Rafael Warsitz, Essen (DE); Aurel Wolf, Wuelfrath (DE)

Correspondence Address: Briscoe, Kurt G.;Norris McLaughlin & Marcus, PA, 875 Third Avenue, 8th Floor, New York, NY, 10022, US

(73) Assignee: BAYER TECHNOLOGY SERVICES GMBH, LEVERKUSEN (DE)

(21) Appl. No.: 12/679,038

(22) PCT Filed: Sep. 9, 2008
(86) PCT No.: PCT/EP08/07345

§ 371 Date: May 28, 2010

(30) Foreign Application Priority Data
Sep. 19, 2007 (DE) 10 2007 044 918.8

(51) Int. Cl. B32B 15/01; B32B 5/18; B22F 1/02

(52) U.S. Cl. 428/546; 428/613; 428/570; 419/64; 419/35

(57) ABSTRACT

The invention relates to a metal matrix material made of a hydrogen-permeable metal 1 and a chemically stable metal 2 that is also hydrogen permeable, said matrix material having a structure comprised of a plurality of centers made of the metal 2 surrounded by the metal 1. The invention further relates to a method for the production of said matrix material, having the following steps: a. optionally pretreating the metal 1 and/or 2 b. coating metal 1 with a metal 2 to form a composite metal powder c. pressing the composite metal powder into the metal matrix material according to the invention in the form of a pressed body d. optionally deforming the pressed body thus obtained to form a molded body. The metal matrix material has a greater mechanical stability as compared to a conventionally coated metal film by virtue of a more homogeneous stress distribution during the change in volume of the metal phases as a result of hydrogen absorption and thermal expansion. At the same time, said material is considerably more chemically stable than conventional coated metal membranes. The metal matrix material is particularly suitable for producing hydrogen-permeable membranes that separate hydrogen from gas mixtures by selective diffusion.

The invention relates to hydrogen-permeable membranes which separate hydrogen from gas mixtures by selective diffusion through a membrane while the diffusion of other gas constituents is blocked by the membrane. In addition, the invention relates to the possible use of the membrane of the invention in membrane reactors for separating off hydrogen.

Hydrogen can be used as clean fuel for powering numerous apparatuses of varying size from a gas turbine for generating electric power through to a very small fuel cell. Use of hydrogen for powering automobiles, ships and submarines is also possible. Furthermore, large amounts of hydrogen are used in the chemical and petrochemical industry. In the chemical industry in particular, hydrogen can be purified by use of hydrogen-permeable membranes. Furthermore, such membranes can be used, for example, for shifting the equilibrium in hydrogenation and dehydrogenation reactions. High-purity hydrogen is also required in the semiconductor industry, so that hydrogen-permeable membranes can also be employed here. In the nuclear industry, membranes are used for separating hydrogen isotopes, helium and other components.

In the field of hydrogen separation, metal membranes display a significantly higher selectivity compared to other membrane materials such as ceramic, glass or polymer. At the same time, the metal membranes have an increased thermal stability.

The membranes used for hydrogen separation frequently comprise palladium which even at room temperature and low hydrogen pressures has a high hydrogen storage capacity. Owing to these advantages, Pd-based membranes have been intensively studied and the state of the research has been presented in various review articles (A. Dixon, Int. J. Chem. Reactor Eng., 1, 2003, R6). However, the Pd foil membranes developed initially could be produced only to a thickness of generally about 75 μm. However, the permeability is insufficient at this thickness. For this reason, Pd layers were applied to ceramic substrates, as described, for example, by Zhao et al. (Catal. Today, 1995, 25, 237). However, such membranes are, when used as intended, subjected to high temperatures at which the differences in the coefficients of thermal expansion between the substrate and the metallic membrane layer together with the embrittlement of the metal layer on contact with hydrogen lead to severe stresses which at suboptimal joins between substrate and membrane layer can lead to detachment. This can lead to failure in the function of the membrane, especially in the case of the large-area plate-shaped substrates which are generally used (see also DE 10,135,390).

Economic factors stand in the way of the use of a pure palladium membrane because of the high price of palladium. In addition, in particular temperature ranges, palladium forms a β hydrid phase which leads to embrittlement and thus to reduced stability of the membrane. The addition of an alloying partner from group VII or IB (for example Ag) was also not able to solve these problems in a fundamental way.

The refractory metals tantalum, vanadium and niobium are possible alternatives to Pd since they have a significantly higher hydrogen permeability and are cheaper than Pd or Pd alloys. However, direct use of these metals as hydrogen-permeable membranes founders on the unsatisfactory chemical resistance, especially due to oxidative attack in an oxygen-containing atmosphere. The oxides formed on the metal surface function as diffusion bathers and thus prevent transport of hydrogen through the membrane.

Attempts have been made in the past to solve this problem by coating these metals with a second, hydrogen-permeable metal (e.g. palladium) in order to avoid chemical attack. DE10057161C2 (Heraeus), for example, describes the production of a metallic membrane for hydrogen separation by, for example, coating of a niobium sheet with palladium on both sides, with a 50 μm thick palladium foil on a 2 mm thick niobium sheet. A Pd/Nb alloy is produced in a targeted manner over the entire thickness of the foil (85% Pd/15% Nb) by high-temperature sintering at 1400° C. Before use, the foil is heated in a hydrogen atmosphere in order to eliminate oxides. Such a membrane has also been produced by means of a sputtered palladium layer and also using an alloy of Nb and Zr. Further publications relating to membranes which differ merely in the method by which the protective Pd layer is applied are known in the literature. For example, U.S. Pat. No. 5,149,420 (Buxbaum and Hsu) describes methods for coating group IVB and VB metals such as niobium, vanadium zirconium, titanium and tantalum with palladium from aqueous solution.

However, such composite or sandwiched membranes display only unsatisfactory long-term stability. Owing to the low chemical resistance under operating conditions, especially due to oxidative attack in an oxygen-containing atmosphere leading to complete oxidation of the membrane if a membrane defect is present, frequent replacement of the membranes is necessary. However, such membranes can therefore not be operated economically. At the same time, large-area activation and high-quality coating of foils of refractory metals has been found to be complicated and expensive.

It was therefore an object of the present invention to develop a material for producing membranes which have a high hydrogen selectivity, hydrogen permeability and a long operating life. Furthermore, a process which allows low-cost production thereof was to be developed.

These objects are achieved by a material as claimed in main claim 1 and also by a process for the production thereof as claimed in main claim 7.

We have found a metal matrix material composed of a hydrogen-permeable metal 1 and a chemically stable, likewise hydrogen-permeable metal 2, which has a structure made up of many centers of metal 1 surrounded by metal 2.

Furthermore, it has surprisingly been found that such a metal matrix material can prevent complete oxidation of the shaped body produced therefrom (e.g. a membrane) and that this at the same time has a higher mechanical stability compared to a conventionally coated metal foil due to a more homogeneous stress distribution on the change in volume of the metallic phases as a result of hydrogen absorption or thermal expansion.

For the purposes of the present invention, the hydrogen permeability of a metal is the value K₀ calculated according to

$${K}_{0} = \frac{l \cdot {Q}_{H 2}}{A \cdot [ {( {p}_{F} )}^{0.5} - {( {p}_{p} )}^{0.5} ]}$$

on the basis of a membrane of the metal having an area A, thickness 1, at a hydrogen flux in mol over the membrane of Q_{H2} at a hydrogen partial pressure on the side of the membrane from which the hydrogen permeates through the membrane surface p_{F} and a hydrogen partial pressure on the side of the membrane from which the permeating hydrogen exits p_{P}. This is preferably greater than

$${10}^{- 10} \frac{mol \cdot m}{{m}^{2} \cdot s \cdot {Pa}^{0.5}} ,$$

particularly preferably greater than

$$5 \cdot {10}^{- 10} \frac{mol \cdot m}{{m}^{2} \cdot s \cdot {Pa}^{0.5}} ,$$

very particularly preferably greater than

$${10}^{- 9} \frac{mol \cdot m}{{m}^{2} \cdot s \cdot {Pa}^{0.5}} ,$$

determined by a method as per examples 24-27 of the present invention.

For the purposes of the invention, a material is chemically stable when it does not form a chemical bond with other atoms or molecules under the use conditions with another material which are conceivable for the invention. In the context of the present invention, a chemical bond is a covalent and/or ionic bond. A particular form of chemically stable is, for the purposes of the present invention, the term oxidation-resistant. This refers here to a chemically stable material which does not form a covalent bond with oxygen, in particular in the uses which are conceivable according to the invention.

Metal 1 in the metal matrix material of the invention is preferably a metal or an alloy or an intermetallic phase or a mixture thereof which can absorb hydrogen and has a higher permeability to hydrogen than metal 2. Metal 1 is particularly preferably a metal from the group of refractory metals. In particular, it is one of the metals niobium, vanadium, tantalum or a mixture (alloy) of these. Very particular preference is given to niobium.

As regards the particle size of metal 1 in the metal matrix material of the invention, average particle sizes of from 0.1 to 1000 μm are preferred. Particular preference is given to average particle sizes of from 1 to 500 μm, very particularly preferably average particle sizes of from 10 to 300 μm.

Metal 2 in the metal matrix material of the invention is preferably an oxidation-resistant metal. Metal 2 is particularly preferably a metal from the group consisting of: palladium, platinum, nickel, cobalt, gold, iron, rhodium, iridium, titanium, hafnium, zirconium and alloys of the metals mentioned and alloys with niobium, vanadium and tantalum.

Metal 2 is very particularly preferably palladium or an alloy thereof since these are resistant to formation of hydrides and surface oxidation and have a particularly high H₂ permeability. Palladium alloys with, in particular, at least one metal of groups IB, IVB, VB and VIB of the Periodic Table as alloying partner can be used. Preference is likewise given to metal 2 being an alloy which is not embrittled by hydrogen, e.g. “Nb 1% Zr, Nb 10 Hf 1 Ti”, Vanstar (trademark) and V15Cr5Ti.

A metal matrix material according to the invention or a shaped body produced therefrom preferably has a porosity below 1%.

The present invention further provides a process by means of which the metal matrix material of the invention can be produced.

The process of the invention for producing a metal matrix material according to the invention comprises at least the following steps:
1. If appropriate pretreatment of metal 1 and/or 2
2. Coating of metal 1 with a metal 2 to give a composite metal powder
3. Pressing of the composite metal powder to give a metal matrix material according to the invention in the form of a compact
4. If appropriate shaping of the compact obtained to give a shaped body.

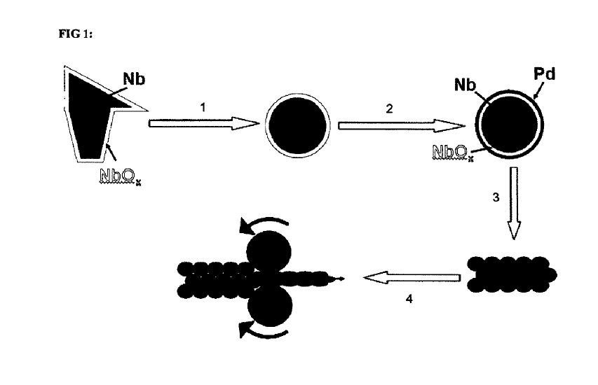

An illustrative schematic production by means of the process is shown in FIG. 1.

In the process of the invention, metal 1 comprises the metals and/or alloys referred to as metal 1 in the metal matrix material of the invention and is preferably a powder.

Powders of metal 1 in the process of the invention are usually selected on the basis of the parameters particle size, purity and porosity and also target properties of the metal matrix material in respect of the proportion by mass of metal 1 to be achieved in the resulting metal matrix material.

For the purposes of the invention, porosity is a value expressed in percent. It is calculated according to

$$Porosity = 100 - \frac{density ( overall )}{density ( material )} \cdot 100.$$

Density (overall) is the value obtained by dividing the weighed mass of the particle or of the shaped body or of the metal matrix material of the invention by the measured volume of particles or shaped bodies or metal matrix material according to the invention. In the case of particles, this is an average over the totality of particles in a powder.

The measurement of a volume is carried out by measuring the external dimensions and calculating the volume.

Density (material) is the specific density of a material as materials property; or in the case of mixtures (alloys) the resulting density determined by proportional addition of the specific densities of the constituents of the mixture (alloy) present in particles or shaped bodies or metal matrix materials.

In the case of the particle size of metal 1, preference is given to average particle sizes of from 0.1 to 1000 μm. Particular preference is given to average particle sizes of from 1 to 500 μm, very particularly preferably average particle sizes of from 10 to 300 μm.

The purity of metal 1 is usually from 98% to 99.99+%, preferably from 99.8% to 99.99+%.

If a larger proportion by mass of metal 1 relative to metal 2 is desirable in the resulting metal matrix material, nonporous metal 1 having a high average particle diameter within the limits indicated above is preferably used. If a low proportion by mass of metal 1 relative to metal 2 is desirable in the resulting metal matrix material, porous metal 1 having a low average particle diameter within the limits indicated above is preferably used.

If a pretreatment as per step 1 of the process of the invention is desirable, this can preferably be carried out by one of or a combination of the processes pickling, nucleation of metal 2 on metal 1 and mechanical rounding. Particular preference is given to a pretreatment which uses the processes pickling, mechanical rounding and/or nucleation of metal 2 on metal 1.

If the process of pickling is desirable as pretreatment, this can preferably be carried out using a pickling agent selected from the group consisting of acids and alkalis. Particular preference is for this purpose given to, for example, HCl, H₂SO₄, HNO₃, H₃PO₄ as acids and NaOH as alkali. Pickling is more preferably carried out at elevated temperature. Temperatures in the range from 80° C. to 150° C. are particularly preferred here.

This process step is advantageous because pickling leads to chemical attack on the surface of the material. Apart from a cleaning effect, roughening of the particle surface which can lead to an increase in the particle surface area, which results in the sometimes desirable higher proportion by mass of metal 2 relative to metal 1 in the resulting metal matrix material, can be achieved in this way. Furthermore, the roughening can lead to a better behavior of metal 1 and/or metal 2 in the subsequent process step 2 according to the invention insofar as more homogeneous coatings can be obtained. Furthermore, it can be desirable to smooth sharp edges and/or obtain scaly surfaces on metal 1 and/or 2, which pickling also allows.

Scanning electron micrographs (e.g. recorded using an SFEGSEM Sirion 100 T or ESEM Quanta 400 T instrument from FEI in accordance with the manufacturer's operating instructions) allow the effect of pickling to be monitored.

If the process of nucleation of metal 2 on metal 1 is desirable as pretreatment, this can, for example, be made possible by the embodiments chemical vapor deposition, physical vapor deposition or wetting with a metal 2 salt solution. Nucleation of metal 2 on metal 1 is preferably effected by wetting with a metal 2 salt solution.

If it is desirable to carry out nucleation of metal 2 on metal 1 by chemical vapor deposition, this can be carried out in one or two stages.

Both embodiments of chemical vapor deposition comprise the use of a precursor of metal 2 and the use of a reactant.

The precursor preferably comprises a metal-organic or inorganic compound of the metal 2 which is vaporizable and thermally stable under vaporization conditions. Particular preference is given to compounds containing metal 2 from the group consisting of: palladium dichloride, Pdacac₂, Pd(hfac)₂, Pad(allyl)₂, Pd(Me allyl)₂, Pd(Me allyl)₂, CpPd(allyl), Pd(allyl)(hfac), Pd(Me allyl)(hfac), PdMe₂(PMe₃)₂, PdMe₂(PEt₃)₂, Pd(acetate)₂, Pd(C₂H₄)₂ and PdMe₂(tmeda).

As reactants, preference is given to using reducing or oxidizing gases, e.g. hydrogen as reducing gas or oxygen as oxidizing gas.

The single-stage vapor deposition preferably comprises the steps:
1. Provision of a precursor of metal 2 in the gas phase
2. Production of a layer-forming species of metal 2 in the gas phase
3. Deposition of the layer-forming species of metal 2 on metal 1.

The two-stage chemical vapor deposition preferably comprises the steps:
1. Provision of a precursor of metal 2 in the gas phase
2. Adsorption of the precursor of metal 2 on the surface of metal 1
3. Chemical reaction of the adsorbed precursor with a reactant on the surface of metal 1 to form metal 2.

The conversion of the precursor of metal 2 is preferably effected by elevated temperature, particularly preferably by temperatures of 0-1000° C., very particularly preferably by temperatures of from 10 to 900° C. and in particular by temperatures of from 20 to 600° C.

Both processes are advantageous since the nucleation of metal 2 on metal 1 forms, in particular, catalytic centers which promote further coating of metal 1 with metal 2. In particular, more homogeneous and denser coatings are in this way achieved later in step 2 of the process of the invention.

If it is desirable to carry out the nucleation of metal 2 on metal 1 by physical vapor deposition, preference is given to using a plasma-aided vaporization process under high vacuum conditions, so that, in particular, atoms or molecules containing metal 2 are brought into the gas phase by physical mechanisms, for example the introduction of thermal energy or momentum transfer by bombardment with high-energy particles, and subsequently condensed in solid form on the substrate.

If it is desirable to achieve nucleation of metal 2 on metal 1 by wetting with a metal 2 salt solution, this preferably comprises the steps:
1. Wetting of pulverulent metal 1 from the process of the invention with a metal 2 salt solution
2. After-treatment of the pulverulent metal 1 containing metal 2 salt solution,
3. Reduction.

The wetting in step 1 is preferably carried out so that the pulverulent metal 1 is completely immersed in a metal 2 salt solution. This is particularly preferably carried out at elevated temperatures. Elevated temperatures preferably encompass 0-300° C., particularly preferably 10-250° C. and very particularly preferably 20-200° C.

The after-treatment preferably comprises complete removal of the solvent under reduced pressure and if appropriate elevated temperature while continually keeping the pulverulent metal 1 with metal 2 salt now present on it in motion.

Here, elevated temperature preferably encompasses the range from 200° C. to 700° C., particularly preferably 500° C.

Wetting/after-treatment steps are particularly preferably repeated a number of times using the same or different salt solutions of metal 2.

The reduction preferably comprises treatment of the particles of metal 1 which have been wetted with metal 2 in a furnace at from 200° C. to 700° C., preferably at about 500° C., under reductive conditions. Reductive conditions comprise, for example, a hydrogen atmosphere.

The reduction of the deposited metal 2 salt leads to formation of metal 2 nuclei on the surface, which leads to an improvement in coating as per step 2 of the process of the invention.

The results achieved can be evaluated by means of, for example, scanning electron micrographs.

If a pretreatment in step 1 of the process of the invention by mechanical rounding is desirable, this is preferably carried out so that the preferably pulverulent metal 1 of the process of the invention comprises a powder having particles having a sphericity close to 1 after the mechanical rounding.

A sphericity close to 1 is advantageous since such particles can for symmetry reasons be coated more homogeneously in step 2 of the process of the invention and more homogeneous coating makes it possible for metal 1 regions to be better delineated in the metal matrix structure resulting from the process of the invention.

For the purposes of the present invention, the sphericity is the ratio of the surface areas of equal-volume, nonporous, spherical particles to the surface areas of the particles obtained. For the purposes of the invention, this preferably comprises a sphericity of 0.25-1, particularly preferably 0.5-1, very particularly preferably 0.75-1.

Carrying out rounding during, for example, the production process (e.g. by separation into droplets or spraying to form round or compact particles from the melt or by means of direct precipitation or crystallization of the correct particle shape from solution) is likewise conceivable.

It is likewise possible to round the particles by chemical (e.g. pickling) or physical (e.g. eroding) processes or a combination thereof. As suitable physicomechanical processes, it is possible to consider systems in which the particles are either deformed to achieve rounding or in which the particles are rounded by breaking off parts of the particles on the surface and the dust produced by mechanical stress is suitably dispersed and separated off from the rounded particles.

Processes for physicomechanical rounding of particles in the preferably pulverulent metal 1 of the process of the invention comprise those which make available high stresses for metals and can be operated under inert conditions and usually with cooling to prevent oxidation of freshly formed surfaces.

The following types of stressing can be employed, inter alia, for physicomechanical rounding of particles of the pulverulent metal 1 of the process of the invention which are present as a dispersion in the gas phase:
Impingement/impact/friction/shearing by particle-particle and/or particle-wall contact in the batch:
An example of a rotor-stator gap system is Hosokawa Alpine Mechanofusion. In this cooled and nitrogen-blanketed apparatus (model Mechanofusion AM-Mini, from Alpine Hosokawa), particles of metal 1, preferably having a homogeneous size, are usually stressed at a speed of rotation of from 2000 to 5000 rpm, preferably from 2500 to 3500 rpm, for from 30 minutes to 3 hours.

Impingement/impact/friction by particle-particle impact, to a limited extent particle-wall impact) in a single pass or multiple passes:
An example of a suitable spiral jet mill is LSM50 from Bayer. The mill can usually be operated under an argon atmosphere using argon as milling gas at an admission pressure of from 5 to 10 bar, preferably from 6 to 8 bar, and a throughput of from 200 to 800 g/h, preferably from 300 to 500 g/h.
Impingement/impact/friction by particle-particle or particle-wall impact in a single pass or a number of passes, e.g. through a rotor impingement mill
Impingement/impact/friction by particle-particle and/or particle-wall contact in the batch: an example of a suitable apparatus is the hybridizer model NHS-0 from Nara, in which the particles of metal 1 can usually be stressed in a nitrogen-blanketed and cooled machine at a speed of rotation of from 8000 rpm to 12 000 rpm over a period of from 1 to 10 minutes.
An example of a fluidized-bed opposed jet mill for stressing is the AFG 100 from Alpine which is usually operated at an admission pressure of 6 bar at the two side nozzles and an admission pressure of 2 bar at the bottom nozzle using nitrogen as milling gas to avoid contact of O₂ with the existing and freshly formed surfaces. The classifier speed of the mill for separating off very fine particles is usually from 5000 to 20 000 rpm, preferably from 8000 to 15 000 rpm.

Among the variants of the type of stressing indicated above, preference is given to using impingement/impact/friction/shear by particle-particle and/or particle-wall contact in the batch, particularly preferably by means of a Mechanofusion AM-Mini from Alpine Hosokawa, impingement/impact/friction by particle-particle and/or particle-wall contact in the batch, particularly preferably by a hybridizer model NHS-0 from Nara, and also to using a fluidized-bed opposed jet mill, particularly preferably a model AFG 100 mill from Alpine.

Processes for physicomechanical rounding in which particles of the pulverulent metal 1 of the process of the invention are dispersed in a liquid phase are also conceivable. To avoid surface contact with oxygen, physicomechanical rounding of this type should preferably take place in a liquid medium which contains no oxygen or only minimal amounts of oxygen. Preferred liquid media in which the physicomechanical rounding takes place are, for example, liquid nitrogen or supercritical media (scCO₂, etc.) which largely avoid contact of surfaces with oxygen and also readily disperse any very fine particles separated off.

The particles of the pulverulent metal 1 of the process of the invention can also be processed in other customary technical systems for the rounding of particles, preferably granulators.

Preferred systems are then rotating pans having a static wall in batch or continuous operation (Sharonizer, from Fuji Paudal) or annular gap systems having a rotating inner and/or outer ring, (e.g. Nebulasizer, from Nara) and also systems which stress the particles by cutting, with a suitable hardness ratio of the particles to the cutting tool and a suitable size range of particles of the pulverulent metal 1 being particularly preferred.

All pretreatments in step 1 of the process of the invention can also be repeated or combined multiply with one another for the purposes of the present invention.

Step 2 of the process of the invention for producing a metal matrix material according to the invention can be carried out using coating processes from the group consisting of mechanical coating, electroless deposition, electrochemical coating, chemical vapor deposition (as described above) and physical vapor deposition (as described above). Preferred variants of step 2 of the process of the invention are electroless deposition and mechanical coating.

If it is desirable to use mechanical coating in step 2 of the process of the invention, metal 2 preferably comprises a powder having a high purity and a particle size matched to the preferably pulverulent particles of metal 1.

The purity of metal 2 is then preferably from 99.8% to 99.999%, particularly preferably from 99.85% to 99.999%, very particularly preferably from 99.9% to 99.999%.

The particle sizes of the preferably pulverulent particles of metal 2 are preferably present in a size ratio at which they are finer than the particles in the preferably pulverulent metal 1. Particular preference is given to a powder of metal 2 having particles which are smaller than the preferred particles of the powder of metal 1 by a factor of at least 10. Particular preference is likewise given to powders of metal 2 which comprise particles in the submicron range.

The mechanical coating comprises, in particular, purely mechanical mixing of the abovementioned preferred powders of the metals 1 and 2 in order to achieve suitable mixing or coating by means of adhesive forces.

Preferred apparatuses for such mechanical coating are 1-D free-fall mixers (e.g. Röhn wheel mixers, drum mixers, container mixers, double cone mixers, Hosen mixers, etc.) or 2-D/3-D free-fall mixers (e.g. Turbula mixers). Particular apparatuses which can be used are mixers having rotating internals and fixed mixing containers (single-shaft horizontal mixers (e.g. plowshare mixers) or two-shaft horizontal mixers (e.g. multistream fluid mixers) and also single-shaft vertical mixers (e.g. high-intensity mixers for mixing-granulation) or two-shaft vertical mixers (e.g. two-shaft ribbon mixers) or fixed internals and rotating mixing containers or combinations thereof (e.g. Eirich mixers). All such mixers can be equipped with additional fast-rotating mixing tools in addition to the main mixing shaft.

It is likewise possible to use systems which are usually not used for mixing but rather for other processes by means of more intensive stressing of particles, e.g. milling media mills with/without milling media (vibratory mills, ball mills, drum mills, attritors, etc.) or impingement mills such as rotor impingement mills or jet mills Opposed jet mills can, for example, be used as a particular process for pneumatic mixing. Specific mechanical processes are designed for tasks of powder design, e.g. mechanical coating based on equally or differently sized particles. In these processes, particle collectives are brought into contact by means of different mechanical stresses. Coatings can be formed by further stressing and/or, if appropriate, with (local) heating, depending on the particle properties. The types of stressing mentioned are realized, for example, in batch-operated impingement mills (e.g. hybridizer, from Nara) or in batch-operated rotor-stator annular gap systems (e.g. Mechanofusion, from Hosokawa Alpine). According to the principle of the hybridizer, a powder mixture having a suitable particle size ratio is initially charged and the machine is operated at a suitable degree of fill and a suitable speed of rotation, a suitable stressing time and with suitable cooling. As a result of the flow generated by the rotor and the resulting gas circulation of the system, the core and coating particles come into contact and the coating particles are mechanically fixed on the core particles by forces of particle-particle contacts or particle-wall contacts.

In the case of another possible principle of mechanofusion, a powder mixture having a suitable particle size ratio is initially charged and the machine is operated at a suitable degree of fill and a suitable speed of rotation, a suitable stressing time and with suitable cooling so that the core and coating particles come into contact in the internal circulation stream based on centrifugal force and the coating particles are mechanically fixed on the core particles by forces of particle-particle contacts or particle-wall contacts.

An alternative embodiment of the coating of the particles of the preferably pulverulent metal 1 comprises electroless deposition.

In the present case according to the invention, this comprises electroless deposition of metal 2 from the liquid phase onto the particles of the preferably pulverulent metal 1.

The process preferably comprises at least the steps:
1. Provision of a coating solution
2. Introduction of particles of metal 1 into the solution obtained from step 1
3. Deposition of metal 2 as coating on the particles of metal 1
4. If appropriate washing and/or filtration of the coated particles
5. Drying.

The coating solution as per step 1 comprises a solvent and at least one precursor.

Preference is given to a precursor which is present as a form of metal 2 which is soluble in the solvent in the coating solution. The soluble form of metal 2 is preferably a metastable metal salt of metal 2 or a metal complex containing metal 2 or both.

The solvent used for the coating solution is preferably water or methanol or a mixture of the two.

In a further embodiment, the coating solution as per step 1 comprises a hydrazine hydrate solution in solvents, which solution preferably contains hydrazine hydrate in a concentration of 0.1-50% by weight and particularly preferably 2-35% by weight.

Step 2 is preferably carried out by stirring particles of metal 1 in the coating solution.

Step 3 is preferably carried out for a relatively long time at elevated temperature. The relatively long time preferably comprises a period of time of from 1 minute to 24 hours, particularly preferably from 10 minutes to 6 hours. The elevated temperature is preferably in the range from 10° C. to 200° C., particularly preferably from 20° C. to 150° C.

Deposition occurs by autocatalytic chemical reduction of the preferably soluble form of metal 2 without application of an electric potential.

This process is advantageous because metal layers can be applied by this means to virtually any workpiece geometry. Furthermore, it is particularly inexpensive since it dispenses with the use of additional energy and requires only a small outlay in terms of apparatus.

The effect of the process can be monitored in a suitable way by means of scanning electron micrographs (FEI, model ESEM Quanta 400 T according to the manufacturer's operating instructions) or by means of ESCA analyses (Ametek, model EDAX Phoenix according to the manufacturer's operating instructions).

In the process of the invention, a composite metal powder whose particles have an average particle diameter d50 of 1-10 000 μm, preferably 10-1000 μm, particularly preferably 30-300 μm, and have a layer thickness of the coating of metal 2 of 0.1-100 μm, preferably 0.1-10 μm, particularly preferably 0.2-5 μm, is obtained after step 2.

In step 3 of the process of the invention for producing a metal matrix material according to the invention, the composite metal powder is pressed to give a compact.

The processing of the composite metal powder obtained according to the invention in step 2 to give the metal matrix material according to the invention in step 3 of the process of the invention is carried out by, for example, one or more powder-metallurgical processes. These comprise pressureless or pressure-aided compaction and are carried out at room temperature or elevated temperature. After compaction, a heat treatment (sintering) can be carried out if appropriate in step 3.

Pressureless powder-metallurgical processes comprise, for example, pouring (e.g. in the case of filters), shaking or vibration and also slip casting.

Pressure-aided powder-metallurgical processes comprise, for example, compaction by means of static pressure on one or more sides in dies having an upper punch and a lower punch, sinter forging, (hot) isostatic pressing (HIP), extrusion and rolling.

A preferred variant of step 3 of the process of the invention comprises pressure-aided pressing which is particularly preferably carried out at elevated temperature. Very particular preference is given to hot isostatic pressing.

It is desirable to carry out a heat treatment in the form of sintering, so that the heat treatment is preferably carried out below the melting point of metal 1 and metal 2. This makes it possible to produce compact bodies having a metallic bond at the contact points without going through melting. Compact metallic parts suitable for further processing are in this way obtained from porous powder compacts by combined action of diffusion and surface tension at elevated temperature.

Suitable pressures in the preferred pressure-aided pressing processes of step 3 are here in the range from 1000 to 2500 N/mm², particularly preferably from 400 to 2000 N/mm², very particularly preferably from 500 to 1800 N/mm² Preferred temperatures encompass temperatures of 10-1000° C. and particularly preferably temperatures of 20-750° C.

A particularly preferred variant of step 3 of the process of the invention is obtained by carrying out the preferred variants under an inert atmosphere such as argon.

A further possible embodiment of step 3 of the process of the invention is obtained when the optionally still porous sintered body (which frequently has a porosity of 10-15%) is subsequently made pore-free by a forming technique.

A very particularly preferred process is hot isostatic pressing (HIP) in an inert gas atmosphere such as argon.

The components to be joined are joined to one another at elevated temperature under an isostatic pressure (the pressure medium is generally argon). The components retain a solid state and no molten phase is formed. This “HIPping” is therefore suitable for the joining of materials having different properties by adhesion. A plurality of welds can often be produced at the same time by means of this technique. The high pressing pressure ensures plastic deformation of the surfaces and thus promotes the diffusion processes which occur.

In a customary HIP process, the components are, for example, firstly maintained at an initial pressure of usually 1 MPa and heated to a set temperature of from 500° C. to 1200° C., preferably from 700° C. to 1100° C., particularly preferably from 800° C. to 1000° C., at a temperature ramp of from 0.1 to 50 K/min, preferably 0.5 to 40 K/min, particularly preferably from 5 to 15 K/min. At the set temperature, the pressure is usually subsequently increased to a set pressure of from 10 to 500 MPa, preferably from 15 to 450 MPa, particularly preferably from 150 to 250 MPa (=250 N/mm²), at a pressure ramp of from 0.1 to 25 MPa/min, preferably from 0.5 to 20 MPa/min, particularly preferably from 2 to 8 MPa/min The component is usually held at the set pressure and set temperature for a period of 1 or more hours.

After this process time, pressure and temperature are usually reduced at the same rates as during heating or increasing the pressure. In the HIP process, a metallic composite having a porosity of <1% can be achieved. The metal matrix material produced in this way can be turned without coolant to give shaped bodies (compacts) having a thickness of from 1 to 80 mm This method is highly economical and environmentally friendly.

The metal matrix material of the invention in the form of a compact can be used in step 4 of the process of the invention for producing shaped bodies. These shaped bodies preferably encompass metal sheets or membranes, particularly preferably gas-separating membranes. The use of these is likewise provided for by the present invention.

The production of shaped bodies as per step 4 of the process of the present invention can comprise various processes. In the case of the particularly preferred membranes, known cutting or noncutting shaping processes can be employed.

In all processes, it is, if appropriate, ensured that no adverse effect on the metallic composite (reactions, gas inclusions, etc.) occurs as a result of the temperature or contact with gases, liquids or solids.

A simple possible way of producing membranes or flat shaped bodies is direct shaping during production of the material to give a metallic composite. The metallic shaped body is then available directly (if appropriate after treatment of the surface by coating or the like) for the application. Another possibility is to cut membranes in the form of slices from larger pieces of material. This can be achieved by conventional cutting parting processes such as turning, sawing or erosion.

While turning and sawing have advantages in the thermal and, depending on the use of cooling liquids, also chemical stressing of the surfaces, very thin metal slices of all conductive materials can be produced by means of erosion. A particular variant of spark erosion is wire erosion, which is particularly preferred as method for producing particularly thin membranes without forming.

A further possible process for producing metal sheets and membranes is rolling in all industrially known embodiments such as cold rolling and hot rolling. Direct (hot) rolling of metal powder at a high temperature, if appropriate with thermal after-treatment, to the target thickness of the membrane is likewise conceivable.

Preference is given to using turning, rolling and/or wire erosion.

In a preferred embodiment of the invention, the membrane surface after step 4 is coated with further metal 2 in a further step in order to protect any exposed metal 1 surfaces against chemical attack or to improve the absorption of hydrogen by metal 1. This coating can be carried out using all processes described above for powder coating, e.g. electrochemical coating, electrolytic coating, electroless deposition, chemical vapor deposition, physical vapor deposition, mechanical coating.

The membranes of the invention obtained from step 4 usually have a membrane thickness of from 0.01 μm to 10 mm, preferably from 0.05 μm to 5 mm, particularly preferably from 0.1 μm to 1 mm.

In a particular embodiment of the membranes of the invention, the hydrogen-permeable membrane layer is applied to a substrate, preferably a porous substrate. Suitable substrates are, for example, porous oxides such as Al₂O₃, SiO₂, ZrO₂, TiO₂ or mixtures thereof.

The membranes of the invention usually have a high permeability to hydrogen which is significantly greater than the specific permeability of palladium. In addition, the membranes of the invention have a high stability. After operation for 3 weeks, no decrease in the permeability was observed.

The invention is illustrated below with the aid of examples without being restricted thereto.

Particular embodiments of the invention are shown in the figures.

FIG. 1 schematically shows the process of the invention, with a pretreatment being carried out in step 1, coating being carried out in step 2, pressing being carried out in step 3 and shaping being carried out in step 4.

FIG. 2 shows in a) and b) in each case the starting material used in example 1 as a scanning electron micrograph (SEM), with an 80× magnification being shown in a) and a 300× magnification being shown in b).

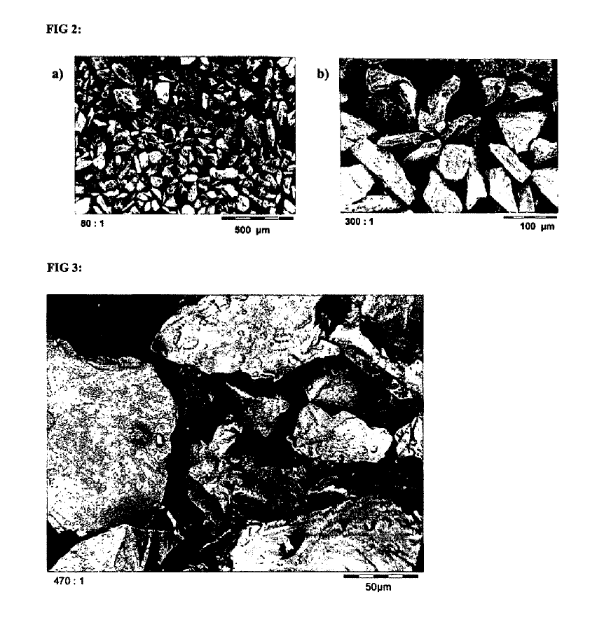

FIG. 3 shows a scanning electron micrograph in which nucleation as per example 4 can be seen.

FIG. 4 shows a scanning electron micrograph in which nucleation as per example 5 can be seen.

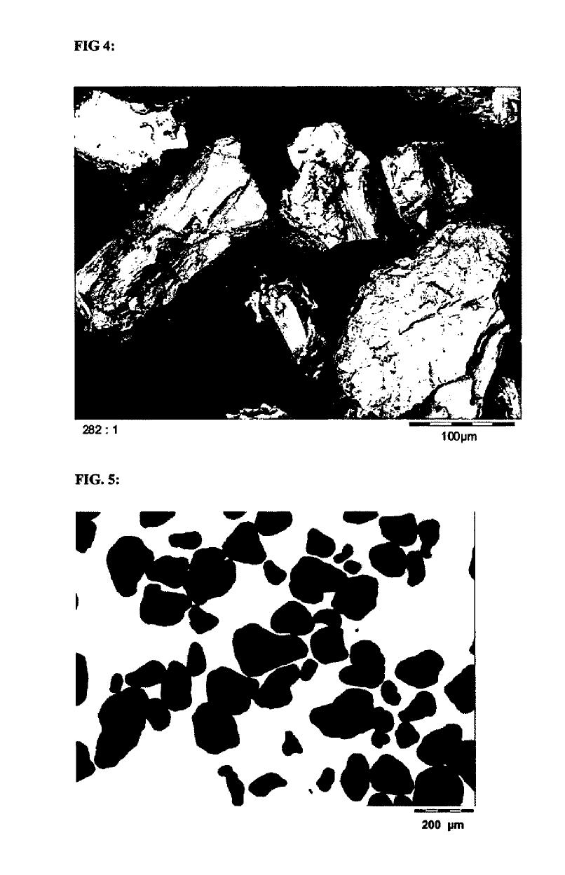

FIG. 5 shows the result of rounding in a fluidized-bed opposed jet mill AFG100 as per example 6 in an optical micrograph in transmitted light.

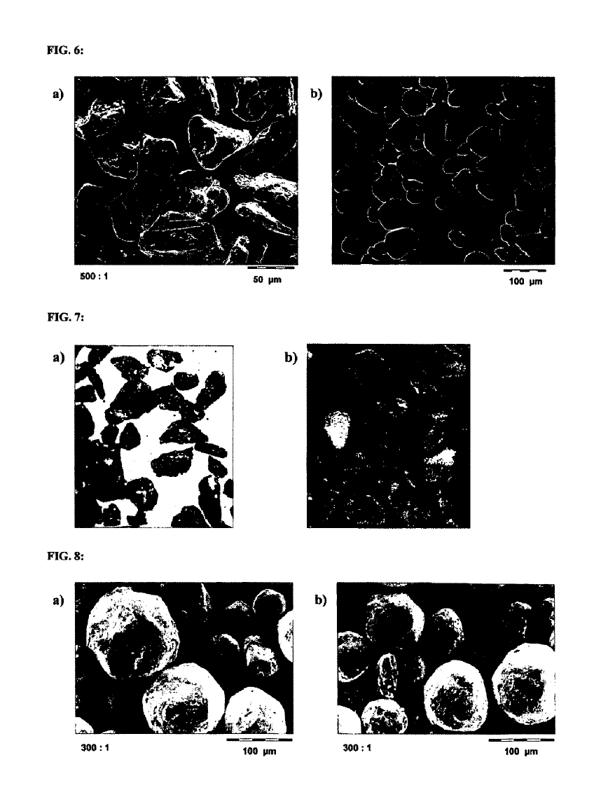

FIG. 6 shows in a) and b) the result of rounding in a spiral jet mill LSM50 as per example 7, with a scanning electron micrograph being shown in a) and an optical micrograph in transmitted light being shown in b).

FIG. 7 shows in a) and b) the result of rounding by means of the Hosokawa Mechanofusion AM-Mini system as per example 8, in each case in an optical micrograph in transmitted light at different light settings.

FIG. 8 shows in a) and b) the result of rounding by the Nara Hybridizer system as per example 9 in a scanning electron micrograph, with a) showing the system NHS0 at 12 000 rpm for 3 minutes at 30×g and b) showing the system NHS1 at 8000 rpm for 3 minutes at 120×g.

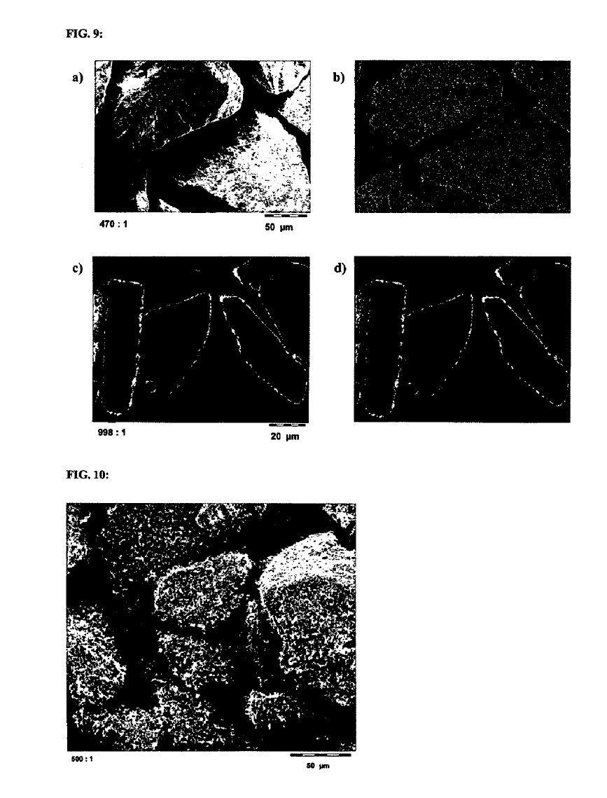

FIG. 9 shows in a), b), c) and d) scanning electron micrographs or “electron spectroscopy for chemical analysis” (ESCA) images of niobium particles which have been coated with palladium by electroless deposition as per example 10. The pure scanning electron micrograph is shown in a). The same image with palladium highlighted is shown in b). FIGS. 9c) and d) show a new image (of a section) in which both niobium and palladium are highlighted in c) while only palladium is highlighted in d).

FIG. 10 shows a scanning electron micrograph of niobium particles coated with palladium by mechanical mixing as per example 11.

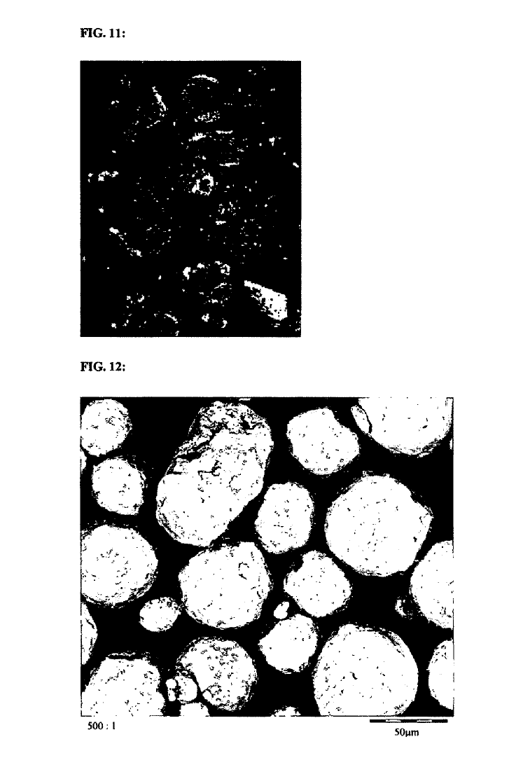

FIG. 11 shows an optical micrograph in transmitted light of niobium particles coated with palladium by means of a Hosokawa Mechanofusion AM Mini as per example 12.

FIG. 12 shows a scanning electron micrograph of niobium particles coated with palladium by means of a Nara Hybridizer NHS-0 as per example 13.

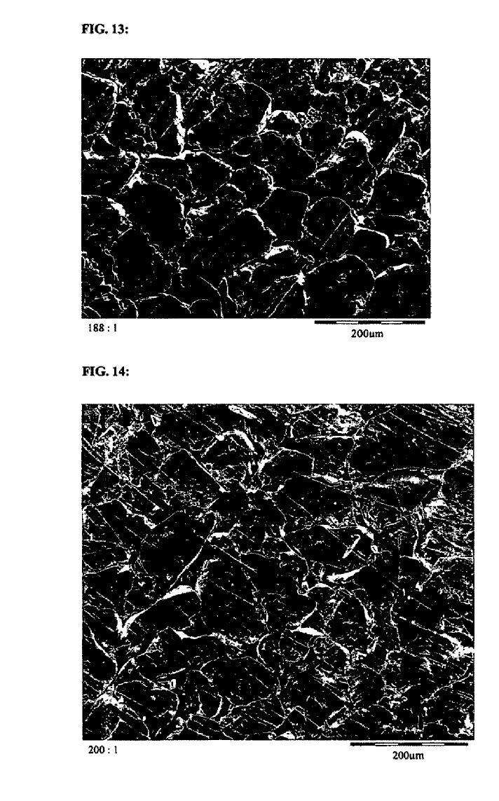

FIG. 13 shows the result of cold pressing of Nb/Pd powder as per example 14 in a scanning electron micrograph.

FIG. 14 shows the result of successive cold pressing and sintering of Nb/Pd powder as per example 15 in a scanning electron micrograph.

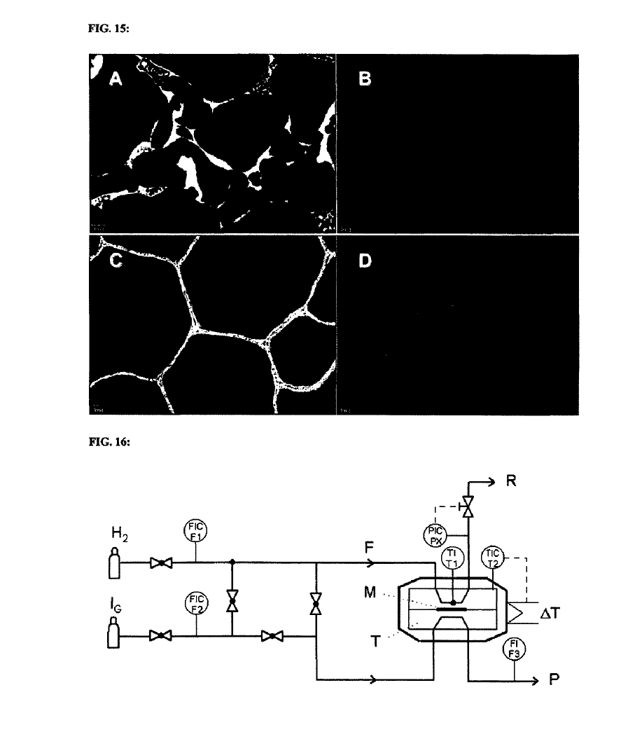

FIG. 15 shows scanning electron micrographs for production of a membrane by means of hot isostatic pressing (HIP) as per example 16, in each case in 500× magnification and recorded at a voltage of 25 kV; (A) Nb/Pd powder mixture, Pd nonuniformly distributed with residual pores; (B) Pd powder applied by means of a Nara hybridizer, 10% of Pd; (C) 5.4% of Pd electroplated on rounded Nb particles; (D) 5.4% of Pd electroplated on unrounded Nb particles.

FIG. 16 schematically shows the test plant for determining the hydrogen permeability using hydrogen (H2) and inert gases (IG), which can be combined to form the feed (F), the membrane (M), the actual test cell (T) and also a heating device (ΔT), so that a permeate (P) and a retentate (T) can be obtained. The measurement facilities depicted in the circles show the type of measurement facility in the upper line and its designation in the lower line. Here, “F” in the first line denotes a flow measurement, “P” denotes a pressure measurement and “T” denotes a temperature measurement. “I” denotes a display for the measured value, “C” denotes a possible control facility for the measured value. Thus, for example, the circle with the first line “TIC” and the second line “T2” refers to a temperature measurement facility designated as T2 which displays the measured temperature and can control the temperature by means of its connection to the heating device (ΔT).

### EXAMPLES

Examples 1 to 27 illustrate the present invention without restricting it thereto.

### Example 1

### Choice of Starting Material

A nonporous niobium powder (EBM, electron beam melted) having a particle size of from about 80 to 150 μm (FIG. 2) was used for the experiments described below.

### Example 2

### Pickling of Niobium Particles by Means of HCl

15 g of niobium as per example 1 were combined with 50 ml of HCl (37%) in a glass beaker and brought to a temperature of 95° C. This temperature was maintained over a period of 5 hours. After the experiment, only a slight weight decrease of <3% was observed. The pickled niobium particles displayed rounding of sharp edges and an alteration of the surface to a slightly scaly structure (evidenced by scanning electron micrographs).

### Example 3

### Wetting of Niobium Particles without after-Treatment

200 g of niobium powder as per example 1 which had been subjected to a pickling step as per example 2 were placed in a rotary evaporator heated to 60° C. by means of a water bath. The powder was wetted with 16 ml of a Pd(NH₃)₄Cl₂ solution and subsequently dried with the product being moved by rotation at a maximum vacuum of about 200 mbar over a period of about 90 minutes. This coating/drying step was carried out a total of 5 times. The product was subsequently dried and used for further coating.

Evaluation of the results achieved after coating was carried out by means of scanning electron micrographs. The treatment led, according to microscopic analysis, to a slight improvement in the coating properties in the subsequent coating step.

### Example 4

### Wetting of Niobium Particles with Thermal after-Treatment

200 g of the product from example 3 were, after drying, subjected to a thermal treatment in an argon-blanketed furnace at 900° C. for a period of 3 hours at the final temperature. The decomposition of the deposited palladium salt which occurs at this temperature led to formation of finely divided palladium nuclei on the surface. This could be confirmed by means of scanning electron micrographs (FIG. 3).

### Example 5

### Wetting of Niobium Particles with Thermal after-Treatment and Reduction

200 g of the product from example 3 were, after drying, subjected to a thermal treatment in a furnace at 500° C. under reductive conditions (H₂ atmosphere). The treatment was carried out over a period of 3 hours at the final temperature. The reduction of the deposited palladium salt which occurs at this temperature led to formation of palladium nuclei on the surface. This could be confirmed by means of scanning electron micrographs (FIG. 4).

### Example 6

### Rounding of Particles by Means of a Fluidized-Bed Opposed Jet Mill

In a fluidized-bed opposed jet mill (AFG100, from Alpine), 900 g of a niobium powder, (as in example 1 but with a particle size distribution of d₅₀ about 100 μm, d₉₀ about 200 μm, d₁₀ about 50 μm) were stressed for 2 hours at an admission pressure of 6 bar at the two side nozzles and an admission pressure of 2 bar at the bottom nozzle using nitrogen as milling gas to avoid contact of O₂ with the existing and freshly formed surfaces. The classifier speed of the mill for separating off the very fine particles was 11 000 rpm. FIG. 5 shows the success of rounding for stressing in the fluidized-bed opposed jet mill.

### Example 7

### Rounding of Particles by Means of a Spiral Jet Mill

Rounding of the product from example 1 (amount of product: 200 g) was achieved by stressing in a spiral jet mill (LSM50, from Bayer). The mill was operated in an argon-flushed glove box using argon as milling gas at an admission pressure of 7.5 bar and a throughput of 400 g/h. FIG. 6 depicts the success of rounding for stressing in the spiral jet mill.

### Example 8

### Rounding of Particles by Means of the “Hosokawa Mechanofusion” System

Rounding of particles in a rotor-stator gap system was carried out in a machine from Hosokawa. In this cooled and nitrogen-blanketed apparatus (model Mechanofusion AM-Mini, from Alpine Hosokawa), 90 g of niobium particles as per example 1, which had previously been classified to 100 μm by means of air classification (model ALS 200, from Hosokawa Alpine, 3 g, 3 min), were stressed at a speed of rotation of 2850 rpm for 60 minutes. After the end of the experiment, the product was cooled before the machine was opened. The rounded powder was classified to 32 μm (model ALS 200, from Hosokawa Alpine, 3 g, 3 min) after stressing, with barely any fines being able to be identified. FIG. 7 shows the success of rounding for stressing in the Mechanofusion AM-Mini system.

### Example 9

### Rounding of Particles by Means of the “Nara Hybridizer” System

The rounding of 100 g of niobium particles as per example 1 was carried out in the hybridizer system from Nara. The particles were cooled and stressed under inert gas at a speed of rotation of 8000 or 12 000 rpm for 3 minutes. The rounding of the niobium particles in the scale-up of the hybridizer system is shown in FIG. 8.

### Example 10

### Coating of Pretreated Nb Particles by Electroless Deposition

An acidic stock solution was produced by addition of 20 ml of concentrated HCl solution (37%) to about 900 ml of deionized water. 10 g of PdCl₂ were added to this solution. 120 ml of deionized water and 715 ml of ammonia solution (28% by weight) were subsequently added to 1 liter of the acidic PdCl₂ stock solution. 25 ml of the solution produced in this way were aged for 3 days and 1.75 g of Na₂EDTA salt were then added. The coating solution produced in this way and 15 g of niobium as per example 1, which had been pretreated as per example 2 and example 4, were placed in a 250 ml stirred glass apparatus with glass stirrer. The stirred vessel was brought to 30° C. by means of a water bath. 10 ml of 25% strength by weight hydrazine hydrate solution were subsequently added at a rate of 5 ml/h over a period of 2 hours and the mixture was subsequently stirred for another one hour at the same temperature. The coated niobium particles were washed, filtered off and dried at 60° C. in a drying oven. The particles displayed virtually complete coverage.

The degree of coverage was found to be 80-98% by means of scanning electron micrographs or ESCA. FIG. 9 shows the result of coating experiments carried out according to this coating method.

### Example 11

### Intensive Mixing as Simplest Case for Mechanical Coating

As simplest case of a coating method, moderately rounded niobium powder as per example 1 (LSM50, argon, 8.5 bar, 400 g/h) was intensively mixed with finely divided palladium powder (manufacturer: Ferro, grade 3101, particle size 0.6-1.8 μm) in a laboratory vibratory mill (model MM200, from Retsch) for 1 hour at a vibration frequency of 30 Hz in a 10 ml zirconium oxide cup. 18 g of niobium powder and 2 g of palladium powder were used for the mixture. FIG. 10 shows the purely mechanical coating of niobium particles with very finely divided palladium powder.

### Example 12

### Mechanical Coating by Means of Hosokawa Mechanofusion

The niobium particles rounded in the Mechanofusion AM-Mini system in example 8 were subsequently coated with very finely divided palladium in this system. For this purpose, about 95.5 g of rounded niobium particles were mixed with about 10.6 g of very finely divided palladium powder and stressed for ten minutes in the cooled Mechanofusion AM-Mini system under inert conditions at a speed of rotation of 3820 rpm. FIG. 11 shows the mechanical coating of niobium particles with very finely divided palladium powder in the Mechanofusion system.

### Example 13

### Mechanical Coating by Means of a Nara Hybridizer NHS-0

The particles which had been rounded in the Hybridizer NHS-0 system in example 9 were subsequently coated with very finely divided palladium in this system. For this purpose, about 27 g of rounded niobium particles were mixed with about 3 g of very finely divided palladium powder and stressed for one minute in the cooled Hybridizer NHS-0 system under inert conditions at a speed of rotation of 12 000 rpm. FIG. 12 shows the mechanical coating of niobium particles with very finely divided palladium powder in the Hybridizer system.

### Example 14

### Cold Pressing of Metal Powders by Means of a Tableting Press

To characterize the deformability and evaluate the pressability of the base material, niobium powder as per example 1 was pressed in a tableting press. Pure cold pressing was able to achieve a porosity of about 5% by rearrangement and deformation of the particles at a pressing pressure up to about 1500 N/mm² The impermeability to gas of these compacts could be increased by sintering. FIG. 13 shows a scanning electron micrograph of the surface of the cold-pressed material.

### Example 15

### Successive Pressing by Means of a Tableting Press/Sintering Under Argon

Rounded and coated niobium particles (Nb material as per example 1, rounding as per example 9, pickling as per example 2, nucleation as per example 4, Pd coating as per example 10) were alternately pressed at about 750 N/mm² and sintered at 1000° C. under argon for 0.25-1 h. FIG. 14 shows a scanning electron micrograph of the surface of the successively cold-pressed and sintered material.

### Example 16

### HIPping of an Individual Membrane

To apply high temperatures and high pressures simultaneously, palladium-coated niobium was hot isostatically pressed. 12 g of niobium samples having differently applied coatings were for this purpose in each case introduced into a steel capsule (diameter: 25 mm) with a tantalum foil as separating layer between powder and steel and the capsule was vacuum-welded. In the HIP process, the capsule was firstly brought to the intended temperature at 10 K/min at a pressure of 1 MPa and the temperature was held for 1 hour. At the set temperature, the pressure was subsequently increased and the capsule was brought to the intended pressure of 200 MPa (200 N/mm²) at 4 MPa/min and the pressure was maintained at the same temperature for 2 hours. After this process time, pressure and temperature were reduced at the same rates as during heating and increasing the pressure. After cooling, shaped metallic bodies having a diameter of about 20 mm and a thickness of about 3 mm were turned off without cooling. In the HIP process under the experimental conditions mentioned, a metallic composite having a porosity of <1% was obtained.

Products used in the HIP experiments:

1. AFG-rounded material, 10% mixture from Retsch mill
Nb material: as per example 1
rounding: as per example 6
Pd coating as per example 10
   2. Nara-rounded material with electroless deposition
Nb material: as per example 1
rounding: as per example 9
Pd coating (including pickling as per example 2, nucleation as per example 4): as per example 10
   3. Nara-rounded material, NHS-0, example 10, 10% of Pd
Nb material: as per example 1
rounding: as per example 9
Pd coating as per example 13
   4. Unrounded material with electroless deposition (example 10)
Nb material: as per example 1
Pd coating (including pickling as per example 2, nucleation as per example 4) as per example 10.

FIG. 15 shows the matrix structure of the coated and subsequently hot isostatically pressed products.

### Example 17

### HIPping of Rod Material

To produce a larger amount of the desired matrix composite of niobium and palladium, about 250 g of a rounded and coated niobium powder were in each case hot isostatically pressed. As in the preceding example, the amount of material was introduced into a capsule having a diameter of 25 mm, the capsule was subsequently vacuum welded and subjected to the same pressure and temperature process. After cooling, shaped metallic bodies having a diameter of about 20 mm and a thickness of about 60 mm were turned without coolant. In the HIP process, a metallic composite having a porosity of <1% was obtained under the abovementioned experimental conditions.

### Example 18

### Turning-Off of a HIPped Membrane Having the Precise Shape for Further Use

The membranes produced in example 17 were turned on a standard lathe without use of coolant fluid to avoid chemical effects on the surface and in particular in deeper layers of the membrane. Turning off from the capsule material of the HIP process gave a membrane thickness of about 1 mm and a diameter of about 20 mm The membranes obtained were used for determining theoretical porosities and for gas impermeability tests.

### Example 19

### Sawing of Thin Slices of the Composite Material by Means of a Diamond Disk

To produce membranes for further testing (see examples 24-27), membranes having a thickness of about 0.3 to 1.0 mm were parted from the rods of the composite according to the invention produced in example 20 by hot isostatic pressing by means of a diamond saw (Labcut 1010, Agar Scientific Ltd., diamond disk 0.5 mm).

### Example 20

### Wire Erosion for Achieving Minimal Material Disk Thicknesses without Shaping

As erosion unit, a unit model FX from Mitsubishi was used. Round membranes having a thickness of from 0.3 mm and 2 mm were parted from rod material from example 20 by means of this unit and, after grinding of the surfaces, were used for permeability tests.

### Example 21

### Coating of the Membrane

A membrane having a thickness of 1 mm and a diameter of 20 mm was placed in a 250 ml stirred glass apparatus with glass stirrer. 50 ml of a coating solution as per example 10 were added. The stirred vessel was brought to 30° C. by means of a water bath. 2 ml of a 25% strength by weight hydrazine hydrate solution were added at a rate of 5 ml/h. After the addition of hydrazine hydrate, the mixture was stirred at the same temperature for another one hour. The coated niobium particles were washed, filtered off and dried at 60° C. in a drying oven.

### Example 22

### Coating of an Nb/Pd Compact by Electrolytic Coating

Metallic cations were deposited as a metallic layer from an electrolyte solution on an electrically conductive substrate by electroplating. At the same time, ions dissolve from a cathode composed of the coating material. No alloying of the base material with the coating material took place during coating of the workpiece.

The following conditions were selected for this experiment:

| | |
|---|---|
| PdCl₂ solution | 20 g/l |
| HCl 37% | 60 ml/l |
| Electrolyte volume | 70 ml |
| Temperature | 50° C. |
| Current density | 0.2-0.8 A/dm² |
| Anode | palladium sheets (L/b/s/27/80.2 mm) |
| Cathode | circular niobium sheet; d = 20 mm |

Under the above-described conditions, a largely dense palladium layer having a thickness of 20-30 μm was achieved after a time of 3 hours.

### Example 23

### Coating by Sputtering/Physical Vapor Deposition

After the production of membranes from the metal matrix material of the invention, the outer surface at which metallic niobium was exposed without coating, was coated with palladium before testing. Coating was effected, after grinding and polishing of the surface and cleaning in an ultrasonic bath of acetone, by means of sputtering using a Sputter Ceater 208HV from Cressington. As coating parameters, a current of 80 mA was set at a sputtering time of 100-200 s with the aim of producing a 100 nm thick layer. The thickness measurement was carried out by means of crystal oscillators which were calibrated to the sputtering material.

### Example 24

### Permeation Test Using PdAg₂₅ Membrane (Material not According to the Invention)

Permeation tests were carried out in a test cell at up to 575° C. The test cell had a seat for flat, round membranes having a diameter of 20 mm The assembly was sealed by means of metal O-rings made of Inconel X-750, and the active membrane area is 2.01*10⁻⁴ m². Heating and temperature regulation were carried out by means of an electric heating sleeve. The membrane temperature was determined in the middle of the test cell by means of a temperature sensor of the NiCrNi type. The feed gas was supplied from compressed gas bottles and the supply was regulated via Brooks 5850 flow regulators. FIG. 16 shows the flow diagram of the test apparatus. To determine the permeability, a PdAg₂₅ membrane (palladium-silver alloy with Pd:Ag=75:25% by weight; manufacturer: Alfa Aesar, membrane thickness: 0.25 mm, membrane area: 1.77*10⁻⁴m², permeate pressure: 1 bar abs) was sealed into the test cell and heated to the desired test temperature while flushing with argon inert gas at 1 bar abs. After the desired temperature had been reached, the inert gas (argon) was slowly replaced by hydrogen and the membrane was maintained under a hydrogen atmosphere for some hours. H₂ loading or an H₂ permeate flux was produced by increasing the pressure on the feed side. The hydrogen flux (m³/m²h) through the membrane was determined by means of a bubble counter (ml/min) by normalization to the membrane area. Conversion or normalization to the partial pressure difference and membrane thickness gave the membrane permeability K₀ in mol*m/(m²*s*Pa^{0.5}) according to the following formula:

$${K}_{0} = \frac{l \cdot {Q}_{H 2}}{A \cdot [ {( {p}_{F} )}^{0.5} - {( {p}_{p} )}^{0.5} ]}$$

where:
K₀=membrane permeability [mol·m/m²·s·Pa^{0.5}]
Q_{H2}=hydrogen permeation (mol/s)
A=membrane area [m²]
l=membrane thickness [m]
P_{F}=hydrogen partial pressure on feed side [Pa^{0.5}]
p_{P}=hydrogen partial pressure on permeate side [Pa^{0.5}]

The results for the PdAg₂₅ membrane permeability are shown in table 3 below.

TABLE 3
Permeabilities of the PdAg₂₅ membrane

| | Feed | | Permeate | | k₀ |
|---|---|---|---|---|---|
| Temperature | pressure | Hydrogen | bubble | Permeate | permeability |
| of membrane | (bar | feed rate | counter | flux | [mol/(m*s* |
| (K) | gauge) | (l/min) | (ml/min) | (m³/h/m²) | Pa\hat{ }0.5)] |
| 672 | 2.0 | 0.50 | 5.46 | 1.85 | 2.46E−08 |
| 672 | 4.0 | 0.50 | 9.41 | 3.19 | 2.51E−08 |
| 673 | 8.0 | 0.50 | 15.48 | 5.25 | 2.57E−08 |
| 673 | 12.0 | 0.50 | 20.87 | 7.07 | 2.66E−08 |
| 675 | 16.0 | 0.50 | 24.00 | 8.14 | 2.55E−08 |
| 674 | 20.0 | 0.50 | 28.24 | 9.57 | 2.62E−08 |
| 768 | 2.0 | 0.49 | 6.32 | 2.14 | 2.86E−08 |
| 768 | 4.0 | 0.49 | 10.67 | 3.62 | 2.86E−08 |
| 770 | 8.0 | 0.50 | 17.46 | 5.92 | 2.89E−08 |
| 770 | 12.0 | 0.50 | 22.86 | 7.75 | 2.91E−08 |
| 770 | 16.1 | 0.50 | 27.43 | 9.30 | 2.91E−08 |
| 770 | 20.1 | 0.50 | 32.00 | 10.85 | 2.96E−08 |
| 844 | 2.1 | 0.50 | 6.96 | 2.36 | 3.09E−08 |
| 852 | 4.1 | 0.50 | 11.71 | 3.97 | 3.11E−08 |
| 849 | 8.0 | 0.50 | 19.20 | 6.51 | 3.18E−08 |
| 850 | 12.1 | 0.50 | 25.26 | 8.56 | 3.21E−08 |
| 849 | 16.0 | 0.50 | 30.97 | 10.50 | 3.29E−08 |
| 847 | 20.0 | 0.50 | 34.28 | 11.62 | 3.18E−08 |

After successful testing or H₂ permeation, the membrane was run down in the reverse running-up order, i.e. the steps depressurization, conversion to inert gas (argon) and cooling to room temperature were carried out in order.

### Example 25

### Permeation Test Using a Membrane According to the Invention

The following membrane according to the invention was tested as in example 24:
Nb material: as per example 1, particle size 80-150 μm
rounding: as per example 9
Pd coating: method analogous to example 10 (including pickling as per example 2, nucleation as per example 4)
HIP: as per example 17
turning-off: as per example 18
coating (including grinding, polishing, cleaning): as per example 23

The results of the membrane permeability are given in table 4 below and show, in comparison with example 24, that the membrane according to the invention has a significantly higher permeability.

TABLE 4
Permeability of the membrane according to the invention

| | Temperature | Feed | | Permeate | | k₀ |
|---|---|---|---|---|---|---|
| Measure- | of | pressure | Hydrogen | bubble | | permeability |
| ment time | membrane | (bar | feed rate | counter | Permeate flux | [mol*m/(m²* |
| (h) | (K) | gauge) | (l/min) | (ml/min) | (m³/h/m²) | s*Pa^{0.5})] |
| 0.17 | 824 | 2.00 | 0.50 | 5.45 | 1.626 | 5.23E−08 |
| 0.83 | 823 | 2.00 | 0.50 | 5.45 | 1.626 | 5.22E−08 |
| 1.33 | 824 | 2.00 | 0.50 | 5.33 | 1.591 | 5.11E−08 |
| 1.75 | 824 | 2.00 | 0.50 | 5.45 | 1.626 | 5.22E−08 |
| 2.08 | 825 | 2.07 | 0.25 | 5.33 | 1.591 | 4.97E−08 |
| 2.83 | 826 | 2.08 | 0.25 | 5.45 | 1.626 | 5.08E−08 |
| 3.83 | 826 | 2.07 | 0.25 | 5.33 | 1.591 | 4.97E−08 |
| 4.58 | 826 | 2.07 | 0.25 | 5.33 | 1.591 | 4.97E−08 |
| 5.33 | 825 | 2.07 | 0.25 | 5.45 | 1.626 | 5.09E−08 |
| 6.42 | 826 | 2.07 | 0.25 | 5.33 | 1.591 | 4.97E−08 |
| 7.50 | 825 | 2.07 | 0.25 | 5.33 | 1.591 | 4.98E−08 |
| 20.75 | 826 | 2.07 | 0.25 | 5.45 | 1.626 | 5.08E−08 |

(membrane thickness: 0.6 mm, membrane area: 2.01*10⁻⁴m², permeate pressure: 1 bar abs)

### Example 26

### Permeation Test Using a Membrane According to the Invention

The following membrane according to the invention was tested as in example 24:
Nb material: analogous to example 1, particle size 80-150 μm
rounding: analogous to example 9
Pd coating: analogous to example 10 (including pickling as per example 2, nucleation as per example 4)
HIP: analogous to example 17
turning-off: analogous to example 18
coating (including grinding, polishing, cleaning): as per example 23

The results of the membrane permeability are given in table 5 below and show that the membrane according to the invention has a high permeability.

TABLE 5
Permeability of the membrane according to the invention

| | Temperature | Feed | | Permeate | | k₀ |
|---|---|---|---|---|---|---|
| Measure- | of | pressure | Hydrogen | bubble | | permeability |
| ment time | membrane | (bar | feed rate | counter | Permeate flux | [mol*m/(m²* |
| (h) | (K) | gauge) | (l/min) | (ml/min) | (m³/h/m²) | s*Pa^{0.5})] |
| 0.33 | 821 | 8.0 | 0.25 | 21.82 | 6.511 | 1.40E−07 |
| 0.67 | 820 | 8.0 | 0.25 | 21.62 | 6.452 | 1.39E−07 |
| 1.00 | 821 | 8.0 | 0.25 | 21.82 | 6.511 | 1.40E−07 |
| 1.33 | 771 | 8.0 | 0.25 | 28.57 | 8.526 | 1.84E−07 |
| 1.50 | 770 | 8.0 | 0.25 | 28.92 | 8.629 | 1.86E−07 |
| 1.75 | 770 | 8.0 | 0.25 | 28.92 | 8.629 | 1.86E−07 |
| 2.00 | 770 | 8.0 | 0.25 | 29.27 | 8.734 | 1.88E−07 |
| 15.08 | 726 | 8.0 | 0.25 | 33.80 | 10.087 | 2.18E−07 |
| 15.25 | 726 | 8.0 | 0.25 | 33.80 | 10.087 | 2.18E−07 |
| 15.50 | 726 | 8.0 | 0.25 | 33.80 | 10.087 | 2.18E−07 |

(membrane thickness: 1.1 mm, membrane area: 2.01*10⁻⁴ m², permeate pressure: 1 bar abs)

### Example 27

### Permeation Test Using a Membrane According to the Invention

The following membrane according to the invention was tested as in example 24:
Nb material: as per example 1, particle size 80-150 μm
rounding: as per example 9
Pd coating: as per example 10 (including pickling as per example 2, nucleation as per example 4)
HIP: as per example 17
turning-off: as per example 18
coating (including grinding, polishing, cleaning): as per example 23

The results of the membrane permeability are given in table 6 below and show a very high permeability for the membrane according to the invention.

TABLE 6
Permeability of the membrane according to the invention

| | Temperature | Feed | | Permeate | | k₀ |
|---|---|---|---|---|---|---|
| Measure- | of | pressure | Hydrogen | bubble | | permeability |
| ment time | membrane | (bar | feed rate | counter | Permeate flux | [mol*m/(m²* |
| (h) | (K) | gauge) | (l/min) | (ml/min) | (m³/h/m²) | s*Pa^{0.5})] |
| 0.50 | 827 | 4.04 | 0.25 | 8.96 | 2.674 | 9.3E−08 |
| 1.00 | 827 | 4.04 | 0.25 | 9.16 | 2.733 | 9.5E−08 |
| 1.50 | 827 | 4.03 | 0.25 | 9.16 | 2.733 | 9.5E−08 |
| 2.00 | 827 | 4.02 | 0.25 | 9.02 | 2.692 | 9.4E−08 |
| 2.50 | 827 | 4.03 | 0.25 | 9.09 | 2.713 | 9.4E−08 |
| 3.00 | 827 | 4.01 | 0.25 | 9.16 | 2.733 | 9.5E−08 |
| 3.50 | 828 | 4.01 | 0.25 | 9.09 | 2.713 | 9.4E−08 |
| 16.58 | 828 | 4.04 | 0.25 | 11.65 | 3.477 | 1.2E−07 |
| 16.83 | 828 | 4.04 | 0.25 | 11.65 | 3.477 | 1.2E−07 |
| 17.08 | 828 | 4.02 | 0.25 | 11.54 | 3.444 | 1.2E−07 |
| 17.33 | 828 | 4.02 | 0.25 | 11.76 | 3.509 | 1.2E−07 |

(membrane thickness: 1.1 mm, membrane area: 2.01*10⁻⁴ m², permeate pressure: 1 bar abs)

As can be seen in the examples, the membrane permeability of our own novel membranes is significantly above the membrane permeability of the commercial PdAg₂₅ membrane.

1. A metal matrix material comprising a hydrogen-permeable metal 1 and a chemically stable hydrogen-permeable metal 2, wherein the metal matrix material has a structure comprised of centers of metal 1 surrounded by the second metal 2.

2. The metal matrix material according to claim 1, wherein metal 2 is oxidation-resistant.

3. The metal matrix material according to claim 1, wherein metal 1 contains at least one metal selected from the group consisting of niobium, vanadium, and tantalum.

4. The metal matrix material according to claim 1, wherein metal 2 contains at least one metal selected from the group consisting of palladium, platinum, nickel, cobalt, gold, iron, rhodium, iridium, titanium, hafnium, and zirconium.

5. The metal matrix material according to claim 1, wherein the matrix material comprises metal 1 particles having an average particle size of from 0.1 to 1000 μm around which a metal 2 coating having a layer thickness of 0.01-100 μm is present.

6. The metal matrix material as claimed claim 1, wherein niobium is selected as metal 1 and palladium is selected as metal 2.

7. A process for producing a metal matrix material, which comprises the steps:
a. optionally pretreating metal 1 and/or 2
b. coating of metal 1 with a metal 2 to give a composite metal powder
c. pressing of the composite metal powder to give a metal matrix material according to the invention in the form of a compact
d. optionally shaping of the compact obtained to give a shaped body.

8. The process according to claim 7, wherein metal 1 is present as powder.

9. The process according to claim 7, wherein the pretreatment of step a. is carried out by one or more processes from the group consisting of pickling, nucleation of metal 2 on metal 1, and mechanical rounding.

10. The process according to claim 9, wherein nucleation of metal 2 on metal 1 is carried out by processes from the group consisting of chemical vapor deposition, physical vapor deposition and wetting with a metal 2 salt solution.

11. The process according to claim 7, wherein coating of step b. is carried out by one or more processes selected from the group consisting of mechanical coating, electroless deposition, electrochemical coating, chemical vapor deposition, and physical vapor deposition.

12. The process according to claim 7, wherein pressing of step c. is carried out by hot isostatic pressing (HIP).

13. The process according to claim 7, wherein the shaping to give a shaped body of step d. is carried out by processes selected from the group consisting of turning, rolling and wire erosion.

14. The process according to claim 7 wherein the pretreatment as per step a. comprises pickling, mechanical rounding and/or nucleation of metal 2 on metal 1 by means of wetting with metal 2 salt solution, wherein the coating as per step b. comprises electroless deposition and/or mechanical coating, wherein pressing as per step c. comprises HIP and wherein shaping to give the shaped body as per step d. comprises turning and/or wire erosion.

15. The process according to claim 7, wherein subsequent coating of the shaped body is carried out after step d.

16. A shaped body comprising the metal matrix material which can be obtained as claimed in claim 7.

17. The shaped body according to claim 16, wherein the shaped body has a thickness of from 0.01 μm to 10 mm, and is flat or cylindrical.

18. The shaped body according to claim 16, wherein it is applied to a substrate.

19. (canceled)

20. The metal matrix material according to claim 5 wherein metal 1 particles have an average particle size of from 10 to 300 μmm, and metal 2 coating have a layer thickness of 0.25-5 μm.

21. The shaped body according to claim 17, wherein the shaped body has a thickness of from 0.1 μm to 1 mm.
